(19) United States
(12) Patent Application Publication
(10) Pub. No.: US 2009/0281703 A1
(43) Pub. Date: Nov. 12, 2009

(54) Cruise control cancel device for passengers in vehicles

(75) Inventor: Robert A. Meilleur, North Bay (CA)

Correspondence Address: Robert A. Meilleur, 208 King St. W, North Bay, ON, P1B 5Z8, CA

(73) Assignee: HUDSON MEILLEUR, ST. CATHERINES (CA)

(21) Appl. No.: 12/151,993

(22) Filed: May 12, 2008

(51) Int. Cl. B60T 8/32

(52) U.S. Cl. 701/93

(57) ABSTRACT

If something drastic happens to the driver of a vehicle that is on CRUISE CONTROL, the passenger(s) has few options to disengage said feature: he can turn off the ignition key possibly locking the steering wheel; he can depress the brake or clutch if he can access them. In the meantime, the vehicle is speeding along out of control. I propose a CRUISE CONTROL CANCEL DEVICE somewhere on the passenger area of the vehicle.

I, Robert a. Meilleur, propose adding a CRUISE CONTROL CANCEL DEVICE on the passenger side of vehicles in case the driver becomes incapacitated.

This can be easily accomplished by installing an on/off switch in series with the cruise control enable switch and routing the associated wires over to the passenger side.

1. I claim this will prevent accidents.

2. I claim this will save lives.

3. I claim this would be a good safety selling point.
